(19) United States
(12) Patent Application Publication
(10) Pub. No.: US 2006/0161474 A1
(43) Pub. Date: Jul. 20, 2006

(54) Delivery of targeted offers for move theaters and other retail stores

(76) Inventors: David Diamond, New York, NY (US); Rachel Petez Emmons, South Pasadena, CA (US)

Correspondence Address: NEIFELD IP LAW, PC, 4813-B EISENHOWER AVENUE, ALEXANDRIA, VA, 22304, US

(21) Appl. No.: 10/565,498

(22) PCT Filed: Aug. 6, 2003
(86) PCT No.: PCT/US03/22498

§ 371 Date: Jan. 23, 2006

(51) Int. Cl. G06Q 30/00

(52) U.S. Cl. 705/14

(57) ABSTRACT

The invention provides a computer system and methods of use for effecting marketing to customers in movie theater stores and other retail stores including cross-marketing, and marketing based upon aspects of movie showings, and methods of identification and use of transaction data related to the same consumer.

### FIELD OF THE INVENTION

The present invention relates to marketing to consumers that go to movie theaters and other retail stores.

### BACKGROUND

Terms used in this application are defined as follows.

Database, in this application, means data organized in some format in a computer memory that can be accessed by an associated computer system. Such a concept is also referred to as a database management system. A database or database management system includes installations of commercial database products such as the Microsoft Access and SQL Server, as well as any set of files stored in computer memory that can be accessed by an associated computer system.

Transaction, in this application, means an exchange involving at least two legal entities. A purchase is a transaction. Receipt of an incentive offer, redemption of an incentive offer, and acceptance of participation in a consumer survey are transactions.

Purchase, in this application, means a transaction involving at least two parties in which cash, check, charge or credit is exchanged for one or more goods and services.

Incentive offer, in this application, means value offered to a consumer the receipt of which by the consumer is contingent upon the consumer entering into a specified transaction. An incentive offer is sometimes referred to as incentive.

POS, in this application, means point of sale, which is the area where a consumer engages in transactions.

Terminal, in this application, means a device by which data can be entered into or output from, such as a kiosk, PC, or telephone.

POS terminal, in this application, means a terminal where transaction data is entered. A POS terminal may also be referred to as a checkout.

Retail store POS terminal, in this application, means a POS terminal physically located inside of or adjacent a retail store such that customers can walk with items from the retail store that they wish to purchase to the retail store POS terminal where they purchase at least one retail store item.

Movie ticket POS terminal, in this application, means a POS terminal physically located inside of or adjacent a movie theater and where the customers can purchase at least movie tickets to the movie theater and walk to the theater with the tickets.

An ATM, in this application, is a machine at which consumers can enter transactions with their financial accounts with an ATM card.

Food POS terminal, in this application, means a POS terminal physically located inside of or adjacent a movie theater such that customers can purchase at least food and beverages to be consumed in the movie theater.

Product purchase data, in this application, includes data regarding products purchased, price of products purchased, date of purchase, time of day of purchase, day of week of purchase, day of month of purchase, type of payment, redemption amounts, products that qualified for redemptions, subscription amount, periodical publication for which a subscription is sold, incentive offer data including incentive identification, an incentive amount, an incentive condition, and CID associated with the purchases.

Transaction data, in this application, means data associated with a specified transaction. Transaction data includes transaction price, transaction date, description of items involved in the transaction, redemptions provided in the transaction, incentives redeemed in the transaction, incentive offers provided in the transaction, location of the transaction (such as POS terminal, POS lane, identification of store), credit authorization data for a credit card used for the transaction, and entities involved in the transaction (such as identifications for the cashier, purchaser, store, credit card company, purchaser's bank account, incentive offerer, and incentive offerer's bank account).

POS data, in this application, is the data entered at or transmitted to a POS terminal in connection with a transaction. POS data may include transaction data and product purchase data.

Redemption data, in this application, is the data entered or transmitted to a POS terminal in connection with a redemption.

UPC, in this application, means a Universal Product Code, and it is a code that uniquely identifies a type of product.

An identification code, or ID, in this application, means an identification code associated with one or more consumers. An ID can be all or part of a credit card number, a driver's license number, a social security number, or an identification code uniquely associated with the consumer or the consumers household.

A movie identification (MID), in this application, is an ID stored in a movie theater's computer system.

A frequent shopper identification (FSID), in this application, means a consumer's frequent shopper ID for a retail store that is stored in the retail store's computer system.

A consumer identification (CID), in this application, means any ID associated with purchase or transaction data for one or more consumers.

Determining whether and which incentives to offer to a consumer between the time that a consumer is determined to be at a POS terminal or a kiosk and then offering the consumer the determined incentives while the consumer is still at the terminal or kiosk is defined herein as “real time” incentive offering, or “real time”.

### OBJECTS OF INVENTION

An object of the invention is to provide a system and method for limiting printing of incentive offers for items sold by movie theaters and retail stores to those incentive offers likely to be accepted.

Another object of the invention is to provide a network hardware structure and method for associating different IDs used by the same consumer with one another.

Another object of the invention is to provide a system and method for effectively promoting sales of movie theater tickets, food items sold at movie theaters, and items sold at non-movie theater retail stores.

Another object of this invention is to provide a system and method for providing incentive offers for movie theaters and non-movie theater retail store products and services.

Another object of this invention is to effectively use networking technology connecting POS systems for movie theaters and POS systems for non-movie theater retail stores to promote sales in both the movie theaters and the non-movie theater retail stores.

### SUMMARY OF INVENTION

These and other objects of the invention are obtained by using a computer system implementing code to determine communications including incentive offers to provide to a specified customer based upon stored movie data, stored transaction data, and stored communications and incentive offer criteria.

The system and methods of its use provide for effecting marketing to customers in retail stores including cross-marketing, and marketing based upon aspects of movie showings, and methods of identification and use of transaction data related to the same consumer. Suitable communications for a consumer with respect to movie theaters are determined based for example upon their prior movie ticket purchases indicative of the classification, ratings of movies they tend to view, and when and how frequently they tend to view movies, including whether they tend to view movies near the movie release date or after the release date.

The system and methods of its use provide for linking transaction data stored based upon transactions in different retail store POS systems by relating IDs used in the different stores by the same consumer to one another, and cross-marketing by offering communications including incentive offers for transactions in one store while the consumer is in another store.

Linking of a consumers' various IDs to one another is accomplished either by soliciting a list of those IDs from consumers or by guessing at IDs for the same consumer by comparing consumer accounts information for consumer transaction at retail stores in physical proximity to one another for retail stores of the type in which the consumer must enter the store to either purchase from the store or use the store's services.

In one aspect, the invention provides a computer system and methods for its use wherein the system comprises a first POS computer system, said first POS computer system comprising a central processing unit, memory, a database of information stored in said memory, and a POS terminal, said central processing unit having read write access to said database in said memory, said POS terminal designed to transmit transaction information and one or more customer IDs associated with a transaction to said central processing unit; stored movie showings data for at least one movie theater store defining movie showings in at least one theater in said at least one movie theater store and stored transactions data defining transactions associated with said at least one movie theater store including at least one of purchase of tickets for showing of movies and purchase of other items sold by said movie theater store; stored incentive offer criteria including at least one of (1) threshold criteria for determining whether an incentive offer should be communicated to a consumer and (2) terms criteria determining terms for said consumer obtaining an incentive defined by said incentive offer, wherein at least one of said threshold criteria and said terms criteria are applicable to transaction data; and said POS terminal including (1) a device for reading or inputting data including both an ID of a customer and identity of products or services being purchased by said customer as part of a transaction and (2) a device for communicating information to said customer while said customer is conducting a transaction at said POS terminal.

Additional aspects related to this aspect are wherein said threshold criteria depend upon transaction data for a plurality of transactions associated with the same customer ID; wherein said threshold criteria depend upon movie showings data; wherein said threshold criteria depend upon movie showings data including movie classification data defining classification or genre of movies; wherein said threshold criteria depend upon movie showings data including movie ratings data defining ratings of movies; wherein said threshold criteria depend upon movie showings data including movie ratings data defining ratings of movies; wherein said threshold criteria depend upon movie transaction data defining customer's prior purchase of tickets for showings of movies; wherein said threshold criteria depend upon movie transaction data defining classifications or ratings of movies for which a customer has previously purchased tickets for showings; wherein said threshold criteria depend upon movie transaction data defining classifications or ratings of movies for which a customer has previously purchased tickets for showings and movie showings data including at least one of classifications and ratings of movies being shown or to be shown in the future in said at least one movie theater store; wherein said terms for said consumer obtaining an incentive defined by said incentive offer include at least one purchase from said first POS computer system of at least one ticket for a showing of a movie, at least one food item, or at least one service item; wherein said terms for said consumer obtaining an incentive defined by said incentive offer include at least one purchase from a second POS computer system other than said first POS computer system of at least of the following: a ticket for a showing of a movie at other than said at least one movie theater store, a food item, and a service item; wherein said terms criteria determining terms for said consumer obtaining an incentive defined by said incentive offer comprise at least one of the following: a record in said database containing a customer ID used during a transaction, no record in said database containing said customer ID, currency volume of prior purchase stored in association with said customer ID, classification of movies tickets for showings of movies purchased in association with the same customer ID; number of tickets purchased for one showing of a movie purchased in association with said customer ID; wherein said terms criteria determining terms for said consumer obtaining an incentive defined by said incentive offer comprise at least one of the following: existence of transactions associated with a customer ID transacted in other than said first POS system; wherein said terms criteria comprise at least one of the following associated with a customer ID transacted in other than said first POS system: a record in said database containing a customer ID used during a transaction, no record in said database containing said customer ID, currency volume of prior purchase stored in association with said customer ID, classification of movies tickets for showings of movies purchased in association with the same customer ID; number of tickets purchased for one showing of a movie purchased in association with said customer ID; wherein said threshold criteria depend upon movie showings data including difference in date of release of movies and current date; and wherein said threshold criteria depend upon time of day, day of week, or day of month.

In additional aspects, the inventions provides implementing code for linking transaction data for transactions transacted in the first POS computer system with transaction data for transactions transacted in a second POS computer system based at least in part upon geographic proximity of stores in which transactions occurred; further comprising data stored linking a transaction data for transactions transacted through said first POS computer system associated with a first customer ID to transaction data for transaction transacted through said second POS computer system associated with a second customer ID; further comprising code for determining whether stored incentive offer criteria are satisfied for a specified ID based upon data associated with transactions from both the first POS computer system and the second POS computer system; further comprising code for communicating an incentive offer contingent upon purchasing in a non-movie theater store using said second POS computer system, and communicating said incentive offer to a customer having a customer ID when said customer ID or an ID associated with said customer ID is identified at said first POS computer system POS terminal in said movie theater store; further comprising code for communicating an incentive offer contingent upon purchasing in said movie theater store using said first POS computer system, and communicating said incentive offer to a customer having a customer ID when said customer ID or an ID associated with said customer ID is identified at said second POS computer system POS terminal of said non-movie theater retail store; wherein said non-movie theater retail store is one of a supermarket, a convenience store, and an gasoline or other motor vehicle fuel station; further comprising a central computer system and a network connecting between said first POS computer system, said second POS computer system, and said central computer system; wherein said central computer system has code for implementing real time processing; wherein said central computer system contains a database storing transaction data in records each including fields for at least 7 of the following: consumer name 503, consumer address, consumer telephone number, consumer email address, ID, FSID, UPCs of items purchased, date of transaction, price of items purchased, credit card type 519, part or all of credit card number, credit card expiration date, fax number, first FSID, second FSID, first MID1, second MID2, and store ID; wherein said central computer system contains a database storing location of stores in records each including fields for at least two of store ID, store location 605, store IP address, store URL, and store type; wherein said first POS computer system contains a database storing movie releases data preferably including fields for at least 4 of the following: title 803, release date, schedule of viewing dates 807, first movie classification 809, second movie classification, movie rating 813, movie length 815, popularity index 817, movie theater store ID, store location, and store ID; wherein said central computer system contains a database storing movie releases records including fields for storing at least 5 of the following: title, release date, schedule of viewing dates, first movie classification 909, second movie classification, movie rating 913, movie length, popularity index 917, movie theater store ID, store location, store ID, and movie theater system ID; and wherein said incentive offer criteria are stored in a central computer system.

### BRIEF DESCRIPTION OF DRAWINGS

FIG. 1 is a schematic overview of computer network system 1;

FIG. 2 is a schematic of movie theater computer system 10;

FIG. 3 is a schematic of retail store computer system 20;

FIG. 4 is a schematic of central computer system 30;

FIG. 5 is a representation of the schema for a transactions table 500 in central computer system database 410;

FIG. 6 is a representation of the schema for a location of stores table 600 in central computer system database 410;

FIG. 7 is a representation of the schema for a transactions table 700 in retail store computer system transactions database 310;

FIG. 8 is a representation of the schema for a movie releases table 800 in movie theater computer system releases database 205;

FIG. 9 is a representation of the schema for movie releases table 900 in central computer system database 410;

FIG. 10 is a representation of the schema for movie theater transactions table 1000 in movie theater computer system transactions database 210;

FIG. 11 is a high level view flowchart showing the generic steps of a computer implemented process of the invention;

FIG. 12 is a middle level view flowcharts showing steps corresponding to step 1110 of FIG. 11 for receiving transaction data including at least an ID from a terminal, ATM, PC, or telephone/computer interface;

FIG. 13 is a middle level view flowchart showing steps corresponding to step 1120 of FIG. 11 that the receiving computer, such as central computer 400, movie theater computer 200, and/or retail store computer 300 follow for analyzing the received data;

FIG. 14 is a middle level view flowchart showing steps corresponding to step 1130 of FIG. 11 for outputting a result of the analysis of data in step 1120.

### DETAILED DESCRIPTION OF PREFERRED EMBODIMENTS

The same reference numeral refers to the same or corresponding elements throughout the figures.

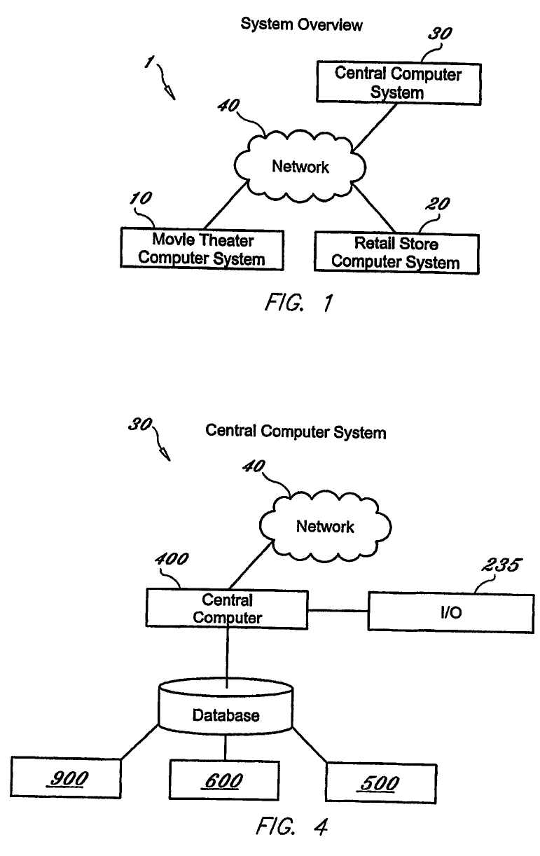

FIG. 1 shows an overview of computer network system 1, including network 40, movie theater computer system 10, retail store computer system 20, and central computer system 30. The lines connecting elements in FIG. 1 indicate a means for data transmission such as wire and wireless transmission hardware, hardware and software providing data transmission, and transmission protocols.

Each one of computer systems 10, 20, and 30 includes at least one digital computer including associated central processor, memory, and input and output devices.

The entities associated with computer systems 10, 20 and 30 are each associated in FIG. 1 with a computer system and preferably with an Internet connection. Not all of that functionality is required to implement certain embodiments of the invention. In implementation, there are preferably a large number of retail store computer systems and movie theater computer systems, and generally only one central computer system. Each system represents one or more central processor units and/or discrete computers linked together to perform specified tasks.

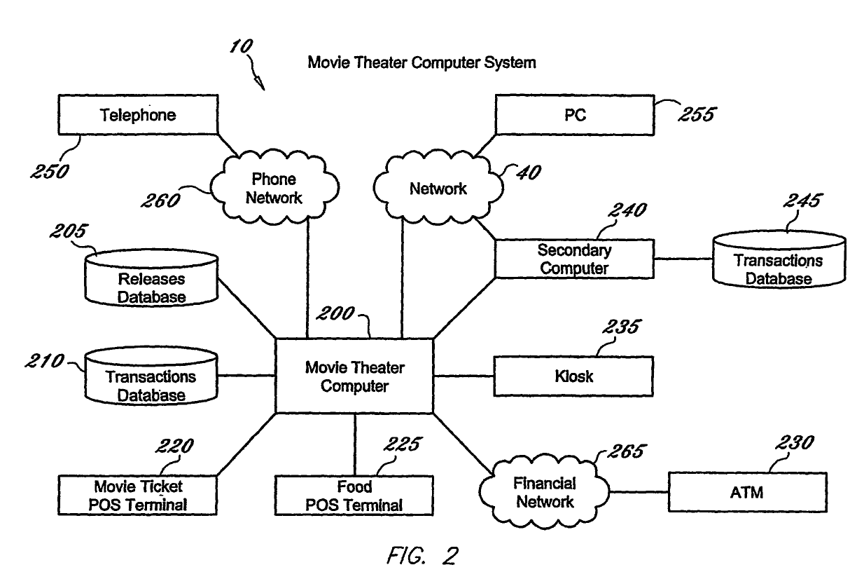

FIG. 2 shows movie theater computer system 10 including movie theater computer 200, releases database 205, transactions database 210, at least one of movie ticket POS terminal 220 and food POS terminal 225. Releases database 205 and transactions database 210 are controlled by movie theater computer 200. Movie theater computer 200 includes data connections shown as connecting lines between elements of the system. Elements connected by only a single line indicate no intervening networks. Databases 205 and 210 may be a single database or file system.

Movie theater computer system 10 may also optionally include ATM 230, kiosk 235, secondary computer 240, telephone 250, personal computer (PC) 255, ATM 230, and any additional means for electronically communicating and transacting with the consumer. Movie theater computer 200 may be connected to each one of kiosk 235, secondary computer 240, telephone 250 and PC 255 so that data may be transmitted between the movie theater computer 200 and the respective terminals.

ATM 230 is connected to movie theater computer 200 via financial network 265.

Telephone 250 is connected to movie theater computer 200 via telephone network 260.

PC 255 is connected to movie theater computer 200 via network 40.

Optional secondary computer 240 either includes a customer purchase history database 245 or has a data connection to transactions database 210 and a data connection to network 40. Network 40 is preferably the Internet, but it may be an intranet.

Movie theater computer 200 preferably is connected to network 40 via a network connection.

Movie theater computer system 10 manages consumer's transaction data and movie data including movie release data relating preferably to at least one movie theater store. It may manage data for a plurality of movie theater stores, such as a plurality of stores owned by the same company. Each movie theater store typically charges a fee to see a movie and sells beverages and food for consumption during a consumer's visit to the movie theater.

Each POS terminal 220, 225, ATM 230, and kiosk 235 preferably includes means to read an ID, such as a credit card number, a driver's license number, a social security number, or means to enable input of some form of consumer identification uniquely associated with the consumer or the consumer's household, so that movie theater computer 200 or central computer system 30 can associate the received ID with previous transaction data stored in association with the ID. The ID may be a CID, a MID, or a FSID. Each POS terminal preferably includes a printer.

Kiosk 235 may include a screen for showing image and text information, and it may include a printer for printing tickets, coupons, and receipts. It may also include a reading device for reading recorded information, such as magnetic data or visual data, including bar codes.

Movie theater computer 200 preferably includes means to decode or identify an ID in data received from telephone 250.

PC 255 and telephone 250 preferably includes means for the consumer to enter an ID and other data and transmit the data to movie theater computer 200.

There are one or more movie theater stores associated with movie theater computer system 10. Each movie theater store is a facility that houses the movie ticket counters, movie concession stands, and at least one theater.

FIG. 3 shows retail store computer system 20 including retail store computer 300, transactions database 3.10, first POS terminal 320, and optionally second and third POS terminals 330 and 340. Transactions database 310 is controlled by the retail store computer 300. Retail store computer 300 includes data connections shown as connecting lines between elements of the system.

Retail store computer system 20 may also include kiosk 350, secondary computer 360, and its transactions database 370, telephone 380 and PC 390, and any additional means for communicating and transacting with the consumer. Retail store computer 300 may be connected to each one of kiosk 350, secondary computer 360, telephone 380 and PC 390 so that data may be transmitted between retail store computer 300 and the respective terminals or network clients. Secondary computer 360 preferably either controls transactions database 370 or has a data connection to transactions database 310, and a data connection to network 40.

Retail store computer 300 may be connected to network 40 via a network connection.

Telephone 380 is connected to retail store computer 300 via phone network 260.

PC 390 is connected to retail store computer 300 via network 40.

Retail store computer system 20 manages data relating preferably to at least one retail store and at least one of those retail stores does not include a movie theater for which it charges fees for viewing movies. Each retail store whose data is managed by system 20 typically sells goods or services in small quantities to consumers, referred to as items.

Each POS terminal 320, 330, and 340 preferably includes means to read a consumer identification, such as a credit card number, a driver's license number, a social security number, or enable input of some form of consumer identification uniquely associated with the consumer or the consumer's household, so that retail store computer 300 or central computer system 30 can associate the received ID with previous transaction data stored in association with the ID. The ID may be a CID, a MID, or a FSID. Typically, the ID is a FSID or a CID previously associated by the retail store computer system 20 with the transaction data stored in transactions database 310. Each POS terminal preferably includes a printer.

Retail store computer 300 preferably includes means to decode or identify data received from telephone 380 as an identification.

Kiosk 350 may include a screen for showing image and text information, and it may include a printer for printing tickets, coupons, and receipts. It may also include a reading device for reading recorded information, such as magnetic data or visual data, including bar codes.

PC 390 and telephone 380 preferably includes means for the consumer to enter an ID which is then transmitted to retail store computer 300.

There are one or more retail stores associated with retail store computer system 20. Retail store computer system 20 preferably functions to control transactions recorded at POS terminals associated with the foregoing retail stores.

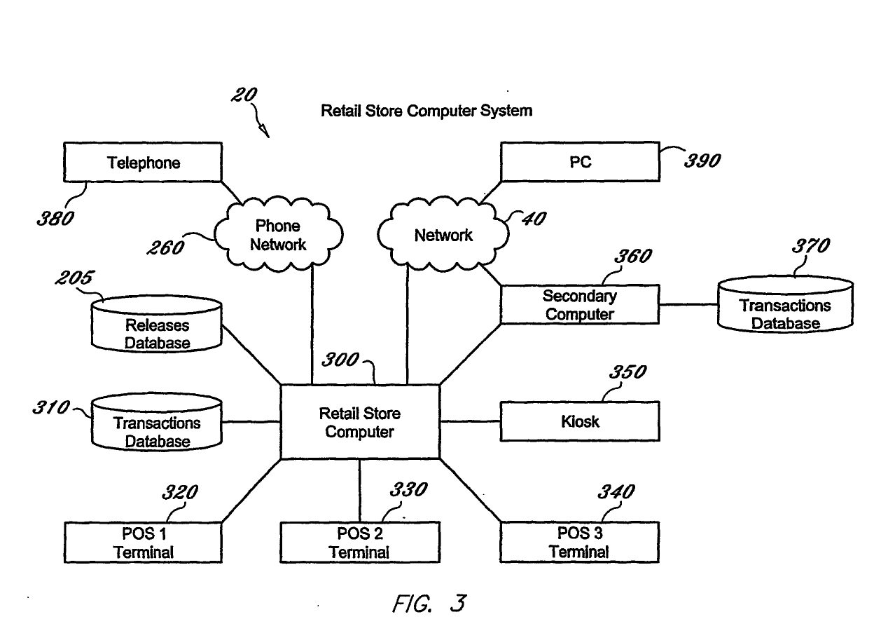

FIG. 4 shows central computer system 30 including central computer 400, central computer database 410, and I/O 420. I/O 420 enables input to and output from central computer 400.

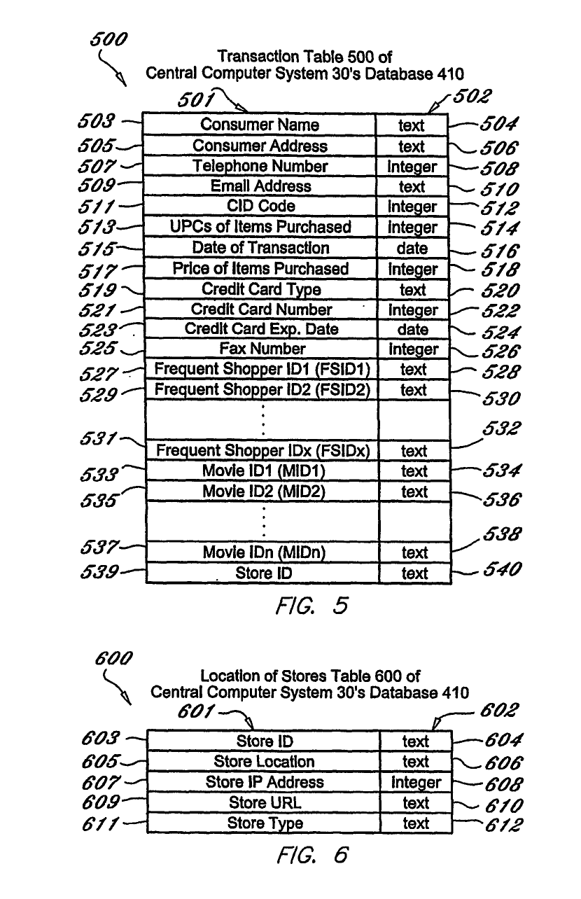

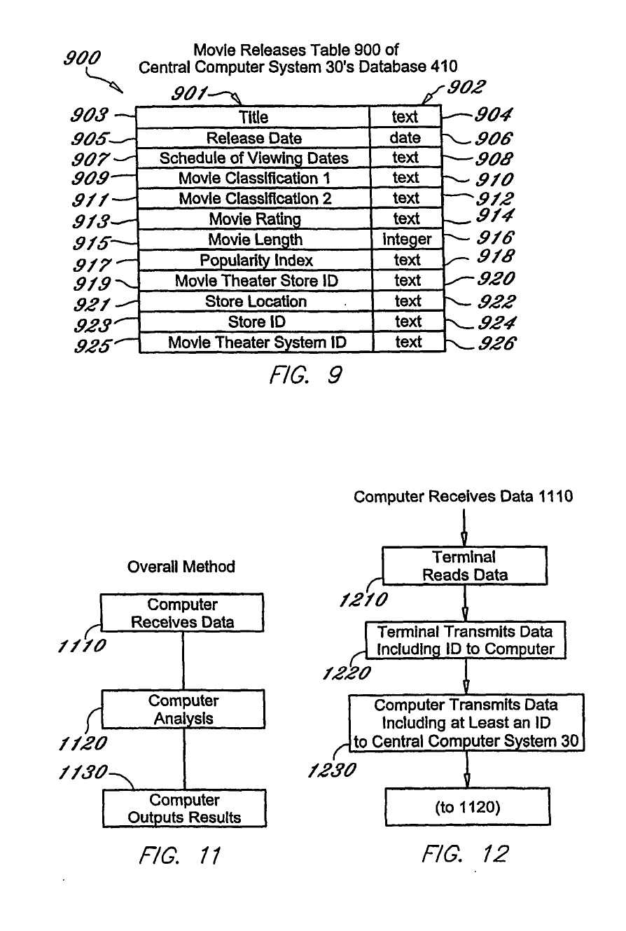

Central computer database 410 preferably contains multiple tables, such as transactions table 500 storing transaction records (see FIG. 5), location of stores table 600 storing location of stores records (see FIG. 6), and movie releases table 900 storing movie release records (see FIG. 9).

Central computer 400 is connected to network 40.

Central computer system 30 is owned by a legal entity, referred to herein as the marketing company. The marketing company typically sells marketing services to other legal entities, including owners of many different types of retail stores, manufacturers of packaged goods, manufacturers of movies, hotels, wholesalers of food, restaurants, and transportation companies, such as airlines, trains, and taxi cab companies. Central computer system 30 preferably assists these other entities by managing and analyzing their POS systems' transaction data to determine how best to serve the customers of those entities, minimize marketing costs of the owners of the retail enterprises and manufacturer suppliers of those enterprises, and maximize sales of the retails stores and manufacturers. Central computer system 30 preferably functions to determine whether to offer an incentive to a consumer identified with a data record associated with retail store computer system 20 or movie theater system 10, and when the determination is to offer the consumer an incentive, transmits an instruction to retail store computer system 20 or to movie theater computer system 10 to offer that consumer that incentive. Central computer system 30 may also function to perform the functions of any of the other computer systems shown in FIG. 1, up to and including acting as remote POS system (virtual POS system) for plural retailer companies.

The marketing company preferably offers marketing programs to its customers, which are retailers, manufacturers of goods and services, and consumers of those goods and services. The marketing company may use central computer system 30 to analyze transaction and product purchase data stored in central computer system 30's database to determine consumer records meeting certain incentive offer criteria. Alternatively, the marketing company may provide to the legal entities owning retail stores or manufacturers of products and services sold in those stores software to perform incentive offer criteria analysis and generation on POS data stored in retail store computer systems' databases. The marketing company uses central computer system 30 and data in its database, via data mining techniques applied to historical POS data and historical incentive marketing programs data to determine individualized communications to consumers and how to transmit those communications to the consumers intended to effect consumer behavior.

FIG. 5 shows a schema for transactions table 500 in central computer system database 410. Transactions table 500 represents data for a consumer's purchase. It shows field names column 501 and data format column 502 for fields of table 500. Each field stores corresponding data. Each record in central computer system database 410 generally contains data for the field names 503, 505, . . . 539 shown in consumer purchase history record 500.

Transaction table 500 preferably includes fields for storing in a record consumer name 503 as data type text 504, consumer address 505 as data type text 506, telephone number 507 as data type integer 508, email address 509 as data type text 510, CID) code 511 as data type integer 512, UPCs of items purchased 513 as data type integer 514, date of transaction 515 as data type date 516, price of items purchased 517 as data type integer 518, credit card type 519 as data type text 520, part or all of credit card number 521 as data type integer 522, credit card expiration date 523 as data type date 524, fax number 525 as data type integer 526, first frequent shopper identification (FSID1) 527 as data type text 528, second frequent shopper identification (FSID2) 529 as data type text 530, . . . , x-th frequent shopper identification (FSIDx) 531 as data type text 532, first movie identification (MID1) 533 as data type text 534, second movie identification (MID2) 535 as data type text 536, . . . , n-th movie identification (MIDn) 537 as data type text 538, store ID 539 as data type text 502.

Each FSID may be the frequent shopper ID a consumer uses in only one retail store and different FSIDs in the same record may be the FSIDs used by the same consumer in different retail stores, or in retail stores owned by different companies. Each movie ID may be an ID used by the consumer in one movie theater store and different movie theater systems. The CID is an ID associated with the consumer. An FSID or a MID are typically assigned to a consumer when the consumer joins a store's frequent shopper program. A store typically prints a card with the consumer's FSID (or MID) and gives the card to the consumer.

Consumer name field 503 stores the name of a consumer.

Consumer address field 505 stores the residence address of the consumer, including street address, city, state, and zip code.

Telephone number field 507 stores the consumer's telephone numbers, such as home phone, work phone, and cell phone.

Email address field 509 stores the consumer's email addresses.

CID code field 511 is an identification number presumed to be unique to a consumer. The CID code can be all or part of a credit card number, a driver's license number, a social security number, a MID, a FSID, or an identification code uniquely associated with the consumer or the consumer's household. Typically, the CID is derived from an account of a financial instrument the consumer uses in transactions. Typically, the CID is derived from a payment instrument account number, such as a credit or debit card or check account number and/or check routing number used by the consumer when conducting transactions.

UPCs of items purchased field 513 is a Universal Product Code, and it is a code that uniquely identifies a type of product.

Date of transaction field 515 stores the transaction data that is stored in purchase record 500.

Price of items purchased field 517 stores the prices for the individual items identified by the UPCs in UPCs field 513.

Credit card type field 519 stores the type of credit card, if products were purchased by credit card, such as Visa or Mastercard.

Credit card number field 521 stores part or all of the credit card account number used during the transaction relating to transaction table 500.

Credit card expiration date field 523 stores the date in which the credit identified in credit card number field 521 expires.

Fax number field 525 stores the consumer's fax number.

First frequent shopper identification (FSID1) field 527, second frequent shopper identification (FSID2) field 529, . . . , and x-th frequent shopper identification (FSIDx) field 531 stores frequent shopper card identifications.

First movie identification (MID1) field 533, second movie identification (MID2) field 535, . . . , and n-th movie identification (MIDn) field 537 store movie theater identification codes linked to a consumer's transaction data stored in movie theater's transactions database 210, such as a credit card number, a driver's license number, a social security number, or an identification code uniquely associated with the consumer or the consumer's household. Movie theaters may assign consumers MIDs when consumers join the movie theater's frequent shopper program. Alternatively, movie theaters can use the FSID account numbers on cards issued by one or several retail stores located in the same area as the movie theater, for each consumer's MID.

Store ID field 539 stores a store identification uniquely associated with a particular store.

Transactions table 500 is exemplary because many different formats may be used to store POS data associated with consumer transactions. For example, data may be stored in third normal form, or in markup form, such as XML. Data also may be reorganized and stored by product instead of by transaction.

FIG. 6 shows a schema for a location of stores table 600 of central computer system database 410. Location of stores table 600 represents data associating the location of movie and retail stores with an identity of those stores. It shows field names column 601 and data format column 602 for fields of record 600. Each field stores corresponding data. Each location of stores record in table 600 of central computer system database 410 generally contains data for the field names shown in location of stores record 600.

Location of stores table 600 preferably includes fields for storing in a record store ID 603 as data type text 604, store location 605 as data type text 606, store IP address 607 as data type integer 608, store URL 609 as data type text 610, store type 611 as data type text 612.

Store ID field 603 stores a unique identification associated with a particular store.

Store location field 605 stores the location of a particular store including the street address of the store, city, state, and zip code and or longitude/latitude and or global positioning system location.

Store IP address field 607 stores the IP address of a particular store.

Store URL field 609 stores the URL of a particular store.

Store type field 611 stores the type of store. Examples include a movie store, a non-movie store, a grocery store, a convenience store, or other.

Store ID in fields 603 and 539 enable linking of tables 500 and 600.

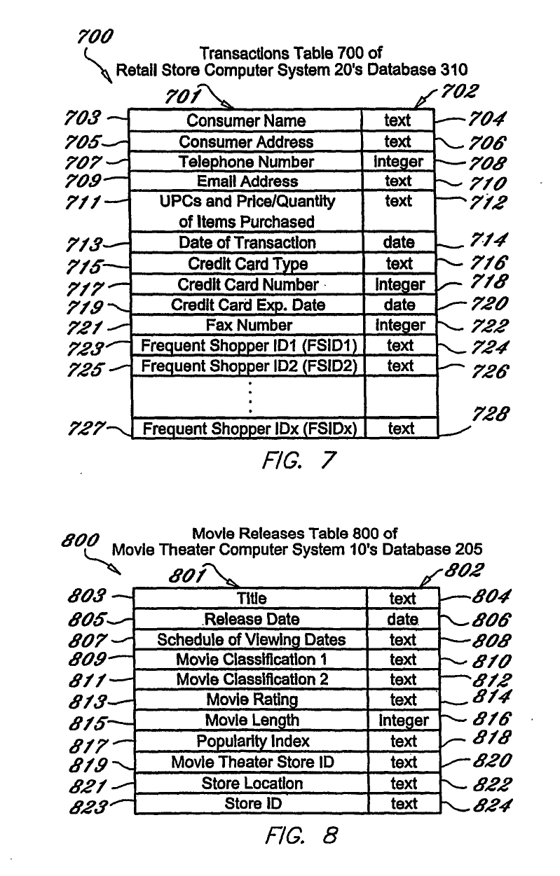

FIG. 7 shows a schema of transactions table 700 from retail store computer system transactions database 310. Transaction table 700 represents data for a consumer's transaction. It shows field names column 701 and data format column 702 for fields of table 700. Each field stores corresponding data Each consumer purchase history record in table 700 generally contains data for the field names 703-727.

Transaction table 700 of retail store computer system transaction database 310 preferably includes fields for storing in each record consumer name 703 as data type text 704, consumer address 705 as data type text 706, telephone number 707 as data type integer 708, email address 709 as data type text 710, UPCs and price/quantity of items purchased 711 as data type integer 712, date of transaction 713 as data type date 714, credit card type 715 as data type text 716, credit card number 717 as data type integer 718, credit card expiration date 719 as data type date 720, fax number 721 as data type integer 722, first frequent shopper identification (FSID1) 723 as data type text 724, second frequent shopper identification (FSID2) 725 as data type text 726, x-th frequent shopper identification (FSIDx) 727 as data type text 728.

Consumer name field 703 stores the name of a consumer.

Consumer address field 705 stores addresses of the consumer, including street address, city, state, and zip code.

Telephone number field 707 stores the consumer's telephone numbers, including home phone, work phone, and cell phone numbers.

Email address field 709 stores the consumer's email addresses.

UPCs and price/quantity of items purchased field 711 stores a UPC is a Universal Product Code, which is a code that uniquely identifies a type of product. It also stores the price of the items purchased and the quantity of items purchased.

Date of transaction field 713 stores a date, or day of week, month, and time of day, of the record.

Credit card type field 715 stores the type of credit card, if products were purchased by credit card, such as Visa or Mastercard.

Credit card number field 717 stores at least part of the credit card number used during the transaction relating to transactions table 700.

Credit card expiration date field 719 stores the date in which the credit identified in credit card number field 717 expires.

Fax number field 721 stores the consumer's fax number.

First frequent shopper identification (FSID1) field 723, second frequent shopper identification (FSID2) field 725, . . . , and x-th frequent shopper identification (FSIDx) field 727 store frequent shopper card identifications.

Transaction table 700 is exemplary because many different formats may be used to store POS data associated with consumer transactions. For example, data may be stored in third normal form or in markup form, such as XML. Data also may be reorganized and stored by product instead of transaction.

FIG. 8 shows a schema for movie data including movie releases table 800 from movie theater computer system releases database 205. Movie releases table 800 represents data for movie releases in movie theaters. It shows field names column 801 and data format column 802 for fields of table 800. Each field stores corresponding data. Each movie release record in releases database 205 generally contains data for the field names shown in movie releases table 800.

Movie releases table 800 preferably includes fields for storing title 803 as data type and text 804, release date 805 as data type date 806, schedule of viewing dates 807 as data type text 808, first movie classification 809 as data type text 810, second movie classification 811 as data type text 812, movie rating 813 as data type text 814, movie length 815 as data type integer 816, popularity index 817 as data type 818, movie theater store ID 819 as data type text 820, store location 821 as date type text 822, and store ID 823 as data type text 824.

Title field 803 is the name of the movie that is released.

Release date field 805 is the date of the release of the movie.

Schedule of viewing dates field 807 stores the schedule of a particular movie including date, time of day, and movie theater room for showing a movie. This is movie showings data.

Movie classification field 809 is the first classification of a movie. For example, the movie could be classified as a drama, comedy, action/adventure, horror, science fiction, classic/musical, mystery, romance, western, foreign, or family.

Movie classification field 811 is the second classification of a movie. For example, a movie might be both a romance and a comedy. Thus, romance would be stored in field 809 and comedy would be stored in 811.

Movie rating field 813 is the rating of the movie. For example, a movie can be rated G, PG-13, R, or X.

Movie length field 815 stores the length of the movie in hours and minutes.

Popularity index field 817 stores comments and ratings from critics and movie surveys. An example of text that could be stored in this field is “Two thumbs up!”

Movie theater store ID field 819 stores an identification for the movie theater that uniquely identifies that theater.

Store location field 821 stores the location of the store, including, for example, the store street address, city, state and zip code and or longitude/latitude and or global positioning system location.

Store ID field 823 stores a store identification uniquely associated with a particular store.

FIG. 9 shows a schema of movies releases table 900 in central computer system database 410. Movie releases table 900 represents data for movie releases in movie theaters. It shows field names column 901 and data format column 902 for fields of movie releases table 900. Each field stores corresponding data. Each movie release record in central computer system database 410 generally contains data for the field names shown in releases table 900.

Movie releases table 900 preferably includes fields for storing title 903 as data type text 904, release date 905 as data type date 906, schedule of viewing dates 907 as data type text 908, first movie classification 909 as data type text 910, second movie classification 911 as data type text 912, movie rating 913 as data type text 914, movie length 915 as data type integer 916, popularity index 917 as data type 918, movie theater store ID 919 as data type text 920, store location 921 as date type text 922, store ID 923 as data type text 924, and movie theater system ID) 925 as data type 926.

Title field 903 is the name of the movie that is released.

Release date field 905 is the date of the release of the movie.

Schedule of viewing dates field 907 stores the schedule of a particular movie including date, time of day, and movie theater room for showing a movie.

Movie classification field 909 is the first classification of a movie. For example, the movie could be classified as a drama, comedy, action/adventure, horror, science fiction, classic/musical, mystery, romance, western, foreign, or family.

Movie classification field 911 is the second classification of a movie. For example, a movie might be both a romantic and a comedic film. Thus, romance would be stored in field 809 and comedy would be stored in 911.

Movie rating field 913 is the rating of the movie. For example, a movie can be rated G, PG-13, or R.

Movie length field 915 stores the length of the movie in hours and minutes.

Popularity index field 917 stores comments and ratings from critics and movie surveys. An example of text that could be stored in this field is “Two thumbs up!”

Movie theater store ID field 919 stores an identification for the movie theater that uniquely identifies that theater.

Store location field 921 stores the location of the store, including the store street address, city, state and zip code and or longitude/latitude and or global positioning system location.

Store ID field 923 stores a store identification uniquely associated with a particular store.

Movie theater system ID field 925 stores an identification uniquely associated with a particular movie theater system.

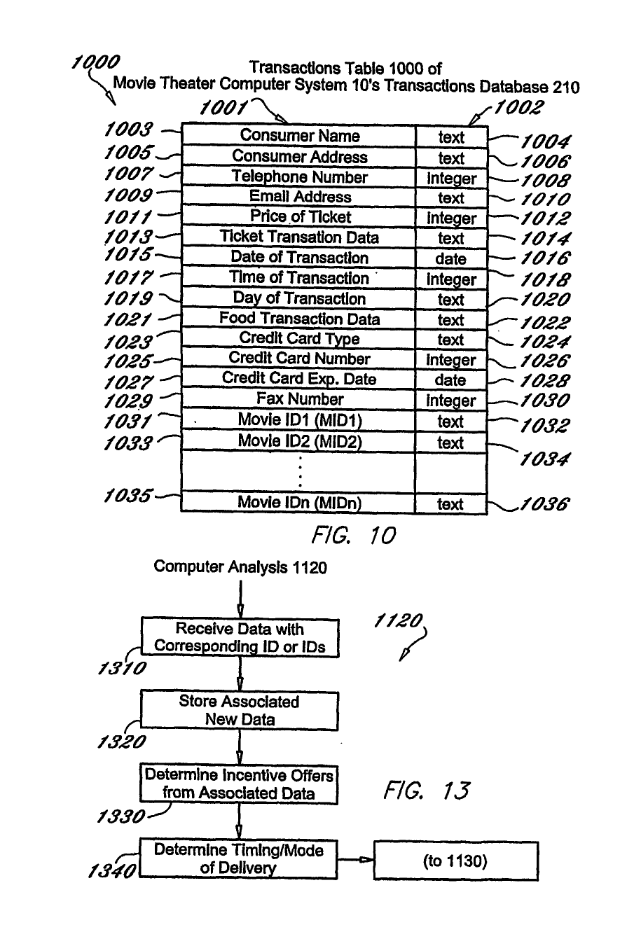

FIG. 10 shows a schema for a movie theater transactions table 1000 in movie theater computer system transactions database 210. Transactions table 1000 represents data for consumers purchases at a movie theater. It shows field names for fields of table 1000. Each field stores corresponding data. Each movie theater transaction record in database 210 generally contains data for the field names column 1001 and data stored column 1002 shown in transactions table 1000.

Transactions table 1000 preferably includes fields for storing in a record consumer name 1003 as data type text 1004, consumer address 1005 as data type text 1006, telephone number 1007 as data type integer 1008, email address 1009 as data type text 1010, price of ticket 1011 as data type text 1012, ticket transaction data 1013 as data type text 1014, transaction date 1015 as data type date 1016, transaction time of day 1017 as data type integer 1018, transaction day of week 1019 as data type text 1020, food transaction data 1021 as data type text 1022, credit card type 1023 as data type text 1024, credit card number 1025 as data type integer 1026, credit card expiration 1027 as data type date 1028, fax number 1029 as data type integer 1030, first movie identification 1031 as data type text 1032, second movie identification 1033 as data type text 1034, n-th movie identification 1035 as data type text 1036.

Consumer name field 1003 stores the name of a consumer.

Consumer address field 1005 stores the address of the consumer, including street address, city, state, and zip code.

Telephone number field 1007 stores the consumer's telephone number, including home phone, work phone, and cell phone numbers.

Email address field 1009 stores the consumer's email address.

Price of ticket field 1011 stores the price that the consumer paid for the movie ticket.

Ticket transaction data field 1013 stores transaction data for a movie ticket purchase by a consumer.

Transaction date field 1015 stores a date of the transaction data for which is stored in transaction table 1000.

Transaction time of day field 1017 stores the time of day in which a transaction occurred.

Transaction day of week field 1019 stores the day of week in which a transaction occurred. For example, this field would store text such as, Monday, Tuesday, Wednesday, Thursday, Friday, Saturday or Sunday.

Food transaction data field 1021 stores transaction data for purchases from the food stand POS terminal in the movie theater, such as UPC or another identification of food items purchased, price of purchase, debates on incentives, incentive offers (such as coupons) issued.

Credit card type field 1023 stores the type of credit card, if products were purchased by credit card, such as Visa or Mastercard.

Credit card number field 1025 stores at least part of the credit card number used during the transaction relating to movie theater transaction table 1000.

Credit card expiration date field 1027 stores the date in which the credit card identified in credit card number field 1025 expires.

Fax number field 1029 stores the consumer's fax number.

First movie identification field 1031, second movie identification field 1033, . . . , and n-th movie theater identification field 1035 store a movie theater identification code linked to a consumer, such as a credit card number, a driver's license number, a social security number, or an identification code uniquely associated with the consumer or the consumer's household.

Movie theater transactions table 1000 is exemplary because many different formats may be used to store movie theater transaction data associated with a consumer. For example, data may be stored in third normal form or in markup form, such as XML. Data may be reorganized and stored by product instead of transaction.

FIG. 11 shows a representation of the overall methods of the inventions.

In step, 1110 a computer receives the transaction and/or POS data.

In step 1120, the computer analyzes the data to determine incentive offers, and/or redemption data associated with transaction data and/or POS data, and timing and mode of deliver of the incentive offers.

In step 1130, the computer outputs the determined incentive offer data and redemption data.

FIG. 12 shows a representation of a middle level view flowchart showing steps corresponding to step 1110 of FIG. 11 a computer receiving data.

In step 1210(a) a terminal reads data or has data entered into it. The terminal may be any one of the previously mentioned terminals, ATM, kiosk, telephone, or home PC. The terminal, kiosk, ATM, telephone, or PC may also read more than one ID, such as a MID and a CID, a FSID and a CID, or a MID and an FSID, and subsequently transmit to the computer receiving the data the plural IDs.

In one embodiment, the terminal reads a MID at a movie ticket POS terminal or a food POS terminal in a movie theater, such that the terminal can transmit the MID and none, some, or all other data received in association with that MID to a local or remote computer. In another embodiment, a terminal reads a FSID or CID at a retail store POS terminal, such that the terminal can transmit the FSID or CID and none, some, or all other data received in association with the ID or IDS to a local or remote computer. In another embodiment, a kiosk reads or receives one or more of a CID, a FSID, and an MID, such that the kiosk can transmit the ID or IDs and none, some, or all other read or entered data received in association with the ID or IDS to a local or remote computer. In another embodiment, a telephone (via a telephone/computer interface) or a PC receives data including one or more CIDs, MIDs, and FSIDs, such that the telephone or PC can transmit the ID or IDs and none, some, or all other read or entered data received in association with the ID or IDS to a local or remote computer.

In step 1220(a), the terminal transmits to the receiving computer data including at least one ID identifying a consumer. In one embodiment the terminal is a dumb terminal in which case data is transmitted to the receiving computer as it is entered into the terminal. In another embodiment, the terminal is a smart terminal with local data storage and processing capabilities. In any case, the terminal transmits in association with the ID none, some, or all other data related to a transaction (transaction data), purchase (product purchase data), or event to a local or remote computer. The data the terminal transmits to the receiving computer may include consumer name, consumer address, telephone number, email address, unique ID number, date, day of week, day of month, time of day, UPCs of product items purchased, data of transaction, price of items purchased, credit card type, credit card number, credit card expiration date, fax number, a frequent shopper ID, a movie ID, and more than one frequent shopper and/or movie ID. The data transmitted to the receiving computer generally may include any of the data information shown in tables 500, 700, 800, and 1000.

The data transmitted to the receiving computer is transmitted to the receiving computer typically along with a logical address for the terminal. The computer receiving the data directly from the terminal, ATM, kiosk, PC, or telephone may be movie theater computer 200, secondary computer 240, retail store computer 300, secondary computer 360, or central computer 400. Any one of the computers other than central computer 400 may either immediately or at some specified time transmit part or all of the data received from the terminal to the central computer 400.

In step 1230, the computer that received the data directly from the terminal, ATM, kiosk, or telephone, if other than the central computer system 30, optionally determines what data to upload to another computer, and to which computer system to upload that data. Upload may be to central computer system 30 or to another POS system computer. For example, the computer receiving the data from the terminal in one POS system may upload the data to the computer controlling part or all of another POS computer system. A movie theater's POS system may upload data to a non movie theater retail store's POS computer system or another movie theater's POS system. A non movie theater packaged goods retailer's computer system may upload data to a movie theater's POS system or another packaged goods retailer's computer system. Preferably, the computer receiving the data uploads the data to another computer system via network 40. Step 1230 is optional.

The data that is identified for uploading may include consumer name, consumer address, telephone number, email address, unique ID number, UPCs of product items purchased, data of transaction, time of day of transaction, day of week of transaction, day of month of transaction, price of items purchased, credit card type, credit card number, credit card expiration date, fax number, first frequent shopper ID, second frequent shopper ID, x-th frequent shopper ID, first movie ID, second movie ID, and n-th movie ID, address of the terminal, and address or identification of the uploading connector or computer system. After step 1230(a), processing proceeds to step 1120. The data that is identified for uploading may generally include any of the data information types shown in tables 500, 600,

FIG. 13 shows the computer analysis steps. The purpose of the computer analysis steps are to determine what incentives to offer to a consumer associated with one or more IDs (including FSIDs and MIDs), when to offer those incentives, and the mode of delivering the incentive offers to the consumer.

In step 1310, a computer receives ID or IDs and none, some, or all of associated transaction and/or product purchase data.

In this step the computer may determine whether a received FSID is linked to a MID or vice versa. The computer may also determine whether there is new transaction or product purchase information that has not previously been stored in association with one of the received IDs in a database local to that computer, and if so, the computer may determine whether to store that information in that database.

In step 1320, the computer may store any new data received in association with an ID in appropriate fields in appropriate tables or in other logical data structures in a database associated with the computer.

Still as part of step 1320, the computer may link records whose FSIDs and MIDs are associated with one another, such as via a common ID or CID. For example, the computer may link records for data obtained from a POS system to one or more other POS systems, including one or more movie theater POS systems and one or more non movie theater POS systems including supermarket POS systems, general retail store POS systems, gasoline station retail POS systems, convenience store retail POS systems, and online stores that sell via purchases transacted over the Internet. One method to link such records is by identifying a portion of the credit card or bank routing number and account number used in a transaction in which a FSID, MID, or CID are provided by the consumer. Another is by expressly requesting the consumer to provide more than one ID. For example, the POS system my solicit the consumer to provide more than one ID, for example by offering an incentive for a future purchase or transaction or a discount on charges for current purchases if the consumer provides additional IDs. More specifically, a retailer POS system may solicit, as part of a transaction at a terminal connected to the retailer POS system, a consumer's MID when also receiving the retailer's FSID or consumer's credit card account number or check account number, a movie theater POS system may solicit, as part of a transaction at a terminal connected to the movie theater's POS system, a FSID when also receiving the MID or the consumer's financial payment account number.

Still as part of step 1320, the computer may link records from different POS systems by capturing part or all of the credit card, bank account or other financial payment account number from transactions made in the different POS systems, and then assuming records from the different POS systems associated with the same part or all of a financial payment account number correspond to the same consumer or household of consumers, and then linking all such records to one another. The step of assuming records from the different POS systems associated with the same part or all of a financial payment account number correspond to the same consumer or household of consumers may be limited to transaction data obtained from stores in the same geographic region, such as one or more adjacent blocks, zip codes, cities, counties, states, or countries for purchases requiring the physical presence of the consumer in the store so that only transaction data for consumers that used the same financial payment account numbers in the same geographic region are assumed to be for the same consumer and linked to one another by the computer. The linking step may be via any type of data structure, such as generations by the computer of a CID and association of the CID with each of the FSIDs, MIDs, and IDs meeting the foregoing financial account or financial account and proximity of use criteria. One particularly useful type of link structure is a links table that associates each new CID with the plurality of other IDs assumed to be for the same consumer of household of consumers.

In step 1330, the computer determines information, such as incentive offers, notifications of product recalls, notifications of general interest, notifications of movie release dates and/or theaters showing the movies, outstanding incentive offers, redeemed incentive offers, totals of redemptions of incentive offers, and mechanisms for redeeming or renewing outstanding inventive offers, to communicate to a consumer associated with an ID based upon data in records associated with the same ID. This data may include data associated with FSIDs and MIDs, linked to the ID.

In step 1330, for incentive offers for the consumer, the computer determines whether data associated with the ID meets specified incentive offer criteria. For non incentive offer communications for the consumer, the computer determines whether data associated with the ID meets specified communications criteria.

In step 1330, for all communications for the consumer, including incentive offers, the computer determines communications applicable to the consumer based upon communications criteria which the computer applies to the data stored in association with the ID. Each one of the aforementioned computer systems may generate communications including communications data and incentive offer data, which means data defining communications and incentive offers associated with an ID, by applying specified communications or incentive offer criteria to data stored in association with the ID. Data stored in association with the ID includes data stored in associated with FSIDs and MIDs linked to the ID, since that data is also associated with the ID via the link. The specified communications or incentive offer criteria data may include demographics, such as age range, geographic location, income range, block data ranges, country, state, municipality, current or transaction data time of day, day of week, day of month, time proximity to a holiday, prior purchase of specified items in a specified period of time at a specified time prior to current time, whether the ID is involved in a transaction in real time, whether postal, email, URL, or other address data is stored in association with the ID, whether the ID is a FSID, a MID, or a CID, dollar volume of purchases in a specified period of time at a specified time prior to current time, dollar volume or number of items of purchases in a specified category of purchases in a specified period of time at a specified time prior to current time, dollar volume or number of items of purchases in a specified period of time at a specified time prior to current time, total dollar volume or number of items purchased, category total dollar volume or number of items purchased, or specific product total dollar volume or number of items purchased stored in the database, frequency of purchases of items, of items in categories, or of specific items as determined from data stored in the database, aperiodicity of purchases of items, of items in categories, or of specific items as determined from data stored in the database, deviations from a pattern of purchases of items, of items in categories, or of specific items as determined from data stored in the database, rate of redemption or number of redemptions of incentive offers by all incentives offered, by value of incentive offered, by category of item or specific items purchase of which was required for redemption of the incentive, location type of redemption (e.g., mail in, POS terminal, Kiosk, ATM, PC, telephone connection, from a non-movie retail store POS system, in a movie store's POS system, in neither a movie store or a non-movie retail store's POS system, from a gasoline stations' POS system, from a convenience store's POS system), frequency, recency, aperiodicity, and deviations from a pattern of redemptions, fraction of purchase, redemptions, or visits online versus in person in a retail store, as measured in number of items, transactions, sessions, and by dollar amount, segmented by product, category, or total purchases and/or redemptions, and via specified time period or for all data stored in the database.

In step 1330, one type of communication is a communication of a product recall based data stored in association with the ID of a product recall for a product purchased in association with the ID.

In step 1330, another set of communications criteria and incentive offer criteria are the current location of the consumer, specifically including whether the consumer is in the movie theater system store, a non movie theater retailer POS systems's store including a supermarket, and convenience store, a gasoline station, and another type of retails store, or not in any retail store as indicated by the identification via logical address of a POS terminal, telephone number of caller, ATM, or PC.

In step 1330, current location of the consumer based communications include communications identifying stores in the same geographic region other than the store the consumer is located in as indicated by terminal logical address, and identifying those other stores via at least name and preferably also location and products and services offered by those stores.

In step 1330, current location of the consumer based communications include communications identifying name or names of movies to be released and preferably their release dates and name or names of recently released movies, and preferably movie theater systems in the same geographic area as the consumer that will or are playing the movie or movies. This communication may be provided at a terminal not associated with a movie theater system, such as a terminal associated with a non movie theater retail store POS system, an ATM, a telephone number, or a PC.

In step 1330, current location of the consumer based communications include communications identifying items for purchase in the POS system associated with the consumers current location. Moreover, the current location of the consumer based communications include communications identifying items for purchase in one or more POS systems not associated with the consumers current location but in the same geographic area as the consumer's current location. For, example, a POS system for a movie theater might provide a communication relating to one more products or services available in either another movie theater or a non movie theater store, such as a supermarket, and convenience store, or a gasoline station in the same geographic area as the location of the movie theater. Similarly, a non-movie theater POS system might provide a communication for one or more products or services available in another non-movie theater POS system, such as a convenience store, a gasoline station, or a supermarket, or products or movies available in a movie theater in the same geographic area as the non-movie theater POS system at a terminal of which the consumer is currently location.

Any of the foregoing communications may include an incentive offer, such as a discount on purchase of one or more than one specified items of products or services from a store other than the store in which the consumer is currently located, or specifying purchases in both stores as conditions for obtaining an incentive. The value of the incentive, such as a discount during a purchase, may be based upon the same types of data noted above for the communication criteria and incentive offer criteria. In addition, the determination wether to offer an incentive offer and the value of an incentive offered may depend in part or in whole upon whether and the extent to which the consumer has previously purchased or redeemed in either the store in which the consumer is currently located, or the store in which purchase must occur to satisfy the terms of the incentive offer.

One type of incentive offer is for a movie playing in a theater located in the same geographic area as the consumer. That offer may depend upon whether the consumer is identified as currently at a terminal the theater in which the movie is or will be playing, at a terminal in another theater in the same geographic area in which the movie will not be playing, or at a terminal in a non-movie theater retail store. The incentive offer may be based upon they classification genre, type, or rating of the movie and whether the consumer's movie viewing record indicates the consumer has viewed that type of classification genre, type, or rating of movie, the number of tickets purchased by the consumer for movie showings of the same or different classification genre, type, or rating, the time of day the consumer previously viewed movies, and specified goods the consumer previously purchased. For example, criteria for offering a communication or incentive offer for a movie rated PG (suitable for children) could be the prior purchase or volume of recent prior purchases of milk, baby formula, frozen dinners, purchase of infant formula, kids toys, purchase of more than 2 tickets for a showing of a movie rated G or PG, per transaction grocery purchases of over a specified amount, such as $200.00, average monthly grocery transaction amount of over a specified amount, such as $500.00. Criteria for offering a communication or incentive offer for a movie rated R or classified as action adventure could be prior viewing of similarly rated or classified movies, prior purchase of alcoholic packaged goods, average grocery purchase value of less than $100.00, average monthly grocery purchase value of less than $300.00, significant monthly purchases from convenience stores, or significant monthly purchases of gasoline or other motor vehicle fuel from gasoline (motor vehicle) stations.

Another type of incentive offer is for purchase of food, beverages, or other services from a movie theater. That is, for purchase of items other than tickets for movie theater showings from the movie theater POS system. Such as incentive offer may be based upon any of the incentive offer criteria noted above. For example, incentive offers for purchase of meat products, such as hamburgers or hotdogs may be based upon purchase of meat products in other stores by the same consumer.

An incentive offer for purchase of food, beverages, or other services from a movie theater's POS system may be based upon the purchase of similar products or services in a non-movie theater POS system. The incentive offer for purchase of food, beverages, or other services from a movie theater's POS system and may depend upon the consumer being identified as at a location not in the non-movie theater, such as a at POS terminal, ATM, telephone number's location, or PC. For example, an incentive offer for purchase of meat based products, such as hamburgers or hot dogs at a movie theater my be communicated to a consumer at a non movie theater POS terminal if the consumer has recently or periodically purchased at least a specified minimum volume of meat products, or has previously purchased hamburgers or hotdogs. An incentive offer for purchase of popcorn in a movie theater may depend upon location of a consumer at a POS terminal in a supermarket and prior purchase by that consumer of popcorn.

Further, communications of a movie theater or incentive offers for transactions including purchase of tickets for showings of movies from that movie theater and the value of those incentives may depend upon the consumer having visited a different movie theater in the same geographic area, and optionally in a specified prior time period.

Further, communications of the existence of non movie theater stores (including supermarket, convenience, and gasoline station) or incentive offers for transactions including purchases from non movie theater stores and the value of those incentives may depend upon the consumer having visited a different supermarket, convenience, and gasoline station store in the same geographic area, and optionally in a specified prior time period.

The system may also communicate an incentive offer requiring both purchase of a ticket and a food item in a movie theater store for obtaining a discount or rebate. The system may communicate incentive offers for discounts or free items of food contingent upon purchased of tickets for showings of the movie in the movie theater store, such as a free small size popcorn. These communications may occur at any terminal, PC, telephone, or ATM identified herein, via email or postal mail to a consumer, or via posting to a web site associated with the consumer, as discussed below.

Another type of criteria that may be used either by themselves or in combination with the other incentive offer criteria mentioned above are a movie manufacturers incentive criteria. These are criteria for incentives sponsored at least in part by manufacturers or movies for viewers to see those movies. For example, the movie studio MGM may offer an incentive to all customers nationwide who previously in the last 6 months have watched movies rated R that were also classified as action adventure movies. Alternatively, the movie manufacturer may offer an incentive depending upon the proximity of the date of release by any other movie manufacturer of a movie having the same classification genre, the same classification genre and rating, or any other set of similarities to the date of release of the movie manufacturer's movie. For example, a movie manufacturer may set up an incentive offer criteria to offer free popcorn or a discount on ticket price for a showing to its movie when another movie manufacturer releases a competing movie in the same classification genre on the same release date.

In summary, the determination of which incentive to offer and whether to offer an incentive for movie theater computer system 10, and retail store computer system 20 preferably depends upon data associated with an ID meeting certain criteria. The criteria may relate to frequency or recency of purchase or redemption, currency amount of purchase or redemption, or the frequency of one or more specified products or incentive offers or products, or any other data or derivatives of the data stores in association with the ID, geographic regions, current location of the consumer, data linked to the consumer's ID, and stores that can be associated with that geographic region.

In various embodiments, a database, such as 205, 210, 245, 310 or 370 stores data indicating a consumer to whom to give a specified incentive offer, whether the incentive was communicated to the consumer, and if not, conditions triggering the delivery of the incentive. In other embodiments, such as real time incentive offering embodiments, movie theater computer system 10 or central computer system 30 determines whether and which incentives to offer to a consumer while a consumer is determined to be at a terminal and provides the incentive offer to the consumer while the consumer is at the terminal; or predetermines the incentives for delivery to a consumer and transmits the incentives to the consumer when the consumer is determined to be at a terminal, such as a POS terminal, ATM, or a Kiosk. A consumer is determined to be at a terminal or a kiosk when they are identified by a device reading an ID or by the consumer manually entering identification information into an input device, such as a keyboard or mouse.

In step 1340, the computer determines timing/mode of delivery. In this step, the computer determines when, where and how to deliver the incentive offers. If a customer is determined to be at a POS terminal or a kiosk, then the incentive offers may be communicated to the consumer in real time. The timing of delivery can also be other than real time delivery. For example the incentive can be mailed 30 days after the customer purchased an item at either the retail store or movie theater. Timing of delivery can be coincided with a time anticipated to be when the consumer will again purchase an item of the same category.

As to timing of communication or delivery of incentive offers, if a consumer typically purchases movie theater tickets at or near a movies release dates, or does so for particular classification or genre's of movies, an incentive may be delivered to the consumer at a time coinciding with the time period when the consumer is likely to purchase tickets for a movie of the same classification, genre, or rating. If the consumer typically purchases tickets for showing of movies a week in advance, the system of the invention may communicate an incentive offer for seeing a movie of the same class, genre, or rating being released in just over one week, and for seeing the movie in a specified movie theater.

If the consumer typically sees movies of a particular class, genre, or rating between 2 and 10 weeks after release dates for movies of that class, genre, or rating, the system of the invention may transmit communications about those movies including one or more theaters of the same movie theater chain in the consumer's geographic area and incentive offers for purchase of tickets for showing of the movie in that or those theaters or incentive offers for other food or products or services sold in that or those movie theaters. The conditions of the inventive offer may specify a period during which the movie will be shown at that or those theaters. The value of the incentive offered for transaction at the movie theater may depend upon the duration of time since the release of the movie. The system may offer the consumer more or large value incentive offers for movies the consumer has not seen depending upon the period of time after the movie has been released, the recent volume of sales for the particular movie. For example, the system may issue incentive offers to consumers for movies when the attendance in the theater falls below a specified number of attendees or fractional occupation of total seats in each showing. The system may offer the consumer one incentive offer for a price reduction or rebate on ticket price for a showing of the movie at the theater early after release date of a movie. If the consumer has not seen the movie by a specified time period after the release date, or after sales on the movie have started to decrease with time after the release date, offer either a larger incentive value for purchase of tickets for showing of the movie at the theater, another incentive offer for a discount or rebate on purchase of other items, such as food or games, at the movie theater alone or in combination with a purchase of one or more tickets for showing of the movie or any movie.

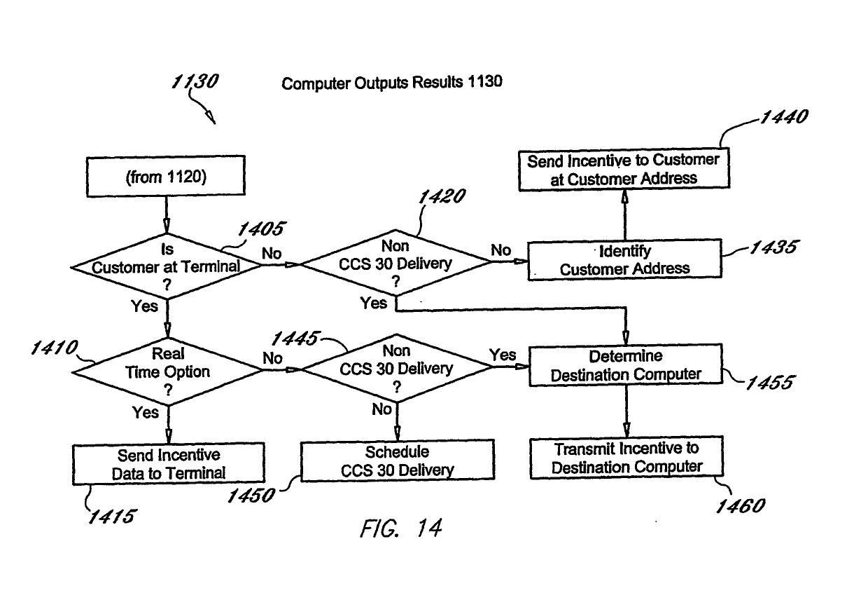

FIG. 14 shows the method for the computer performing step 1130 of outputting the results of the analysis. The outputting or storing of results depends upon whether the computer is a retail store POS system's computer, the central computer, whether delivery of the communication or incentive is real time, non real time, either, and the mode of delivery.

In step 1405, the computer performing the analysis step 1120 determines whether the ID is for a customer currently at a terminal. This determination is preferably made by the computer determining whether the information containing the consumer's ID is just received from a terminal, such as POS terminal, and alternatively whether the information received does not include data indicating a transaction involving the ID has been completed. If yes, processing proceeds to step 1410.

In step 1410, the computer determines whether real time communication or incentive data exists for this ID. If the real data exists, processing proceeds to step 1415.

In step 1415, the computer immediately sends the communication or incentive offer data to the terminal.

In step 1410, if the real time option was not selected, then processing proceeds to step 1445.

In step 1445, the computer determines whether the delivery of the communication or incentive offer is to be performed by a computer system other than the central computer system 30. If delivery of the communication or incentive offer is to be performed by a computer system other than the central computer system 30, processing proceeds to step 1455. Otherwise, processing proceeds to step 1450. At some point after the destination computer is determined, the computer performing the processing transmits the communication or incentive offer data associated with the ID to the destination computer 1460. Timing may be such that transmission is immediate, in response to the determination is step 1445, or period and typically part of a file containing communication and incentive data for plural IDs.

Moreover, delivery the delivery option for real time processing or posting to a URL associated with the consumer's ID may be contingent upon the central computer system 30 either transmitting the data in response to a real time transaction or being notified that the data posted to the URL was accessed (web server may be programmed top notify the central computer system 30 or accessed web pages), such that delivery option changes to some other mode of delivery after a specified time period. For example, if no real time transactions involving a consumer's ID occur within 2 weeks of storing a real time communication for the consumer, central computer system 30 may transmit the communications and incentive offers data for the consumer to the consumer's email address, generate and transmit to a fulfillment house to postal mail printed version of the communications and incentives to the consumer's postal address, or transmit the communications and incentive offers data to one or more retailer POS systems for deliver to the consumer during subsequent transactions in the corresponding stores. Thus, real time data option may convert to step 1440 or 1460 if not effected in a specified time period.

In step 1405, if the computer system performing the analysis determines that the customer is not currently at a terminal, then processing proceeds to step 1420.

In step 1420, the computer determines whether the delivery of the communication or incentive offer is to be performed by a computer system other than the central computer system 30. If delivery of the communication or incentive offer is to be performed by a computer system other than the central computer system 30, processing proceeds to step 1455. Otherwise, processing proceeds to step 1435.

In step 1435, the computer performing the analysis either identifies the customer's address 1435 or transmits the data relating to the customer's ID to central computer system 30 for that identification.

In step 1440, central computer system 30 determines and implements the mode of non real time transmission of communications and/or incentive offers to the consumer. These methods may include direct postal or email, uploading data to a URL associated with the consumer, such as a personal web page URL personalized for the consumer.

There must be a business reason for one store to offer incentives for purchase in another company's store. Generally speaking, that business reason is either a reciprocal service or money.

In embodiments where retail stores offer incentives for purchase in other retail stores, preferably, each such retail store transmits their incentive offer and incentive offer redemption data to central computer system 30. Central computer system 30 accounts for the incentive offers contingent upon purchase of items in stores of company A which are issued at stores of company B, and vice versa, and optionally the redemptions of those incentives, their amounts, types of items, and related terms. Central computer system 30 can generate transaction reports identifying the numbers of issued and redeemed incentives and all related data. Central computer system 30 can manage accounts set up for retailers A and B, and for the marketing company, debiting and crediting those accounts based upon the specifications issued and redeemed incentive offers in each store as predefined in a contract involving parties A, B, and the manufacturing company.

In embodiments where manufacturers, such as movie manufacturers or packaged goods manufacturers, offer incentives for purchase in retail stores, preferably, each such retail store transmits their incentive offer and incentive offer redemption data to central computer system 30. Central computer system 30 accounts for the incentive offers contingent upon purchase of items in retail stores which are issued by the manufacturer, and optionally the redemptions of those incentives, their amounts, types of items, and related terms. Central computer system 30 can generate transaction reports identifying the numbers of issued and redeemed incentives and all related data. Central computer system 30 can manage accounts set up for manufacturer, the retailers, and for the marketing company, debiting and crediting those accounts based upon the specifications of issued and redeemed incentive offers in each store as predefined in a contract involving the manufacturer, the retailers, and the marketing company.

In embodiments where manufacturers, such as movie manufacturers or packaged goods manufacturers, contribute to redemption with retailers for the cost of redeeming incentive offers for purchase in the retail stores, preferably, each such retail store transmits their incentive offer and incentive offer redemption data to central computer system 30. Central computer system 30 accounts for the incentive offers contingent upon purchase of items in retail stores which are issued by the manufacturer, and optionally the redemptions of those incentives, their amounts, types of items, and related terms. Central computer system 30 can generate transaction reports identifying the numbers of issued and redeemed incentives and all related data. Central computer system 30 can manage accounts set up for manufacturer, the retailers, and for the marketing company, debiting and crediting those accounts based upon the specifications of issued and redeemed incentive offers in each store as predefined in a contract involving the manufacturer, the retailers, and the marketing company.

1. A computer system comprising:
a first POS computer system, said first POS computer system comprising a central processing unit, memory, a database of information stored in said memory, and a POS terminal, said central processing unit having read write access to said database in said memory, said POS terminal designed to transmit transaction information and one or more customer IDs associated with a transaction to said central processing unit;
stored movie showings data for at least one movie theater store defining movie showings in at least one theater in said at least one movie theater store and stored transactions data defining transactions associated with said at least one movie theater store including at least one of purchase of tickets for showing of movies and purchase of other items sold by said movie theater store;
stored incentive offer criteria including at least one of (1) threshold criteria for determining whether an incentive offer should be communicated to a consumer and (2) terms criteria determining terms for said consumer obtaining an incentive defined by said incentive offer, wherein at least one of said threshold criteria and said terms criteria are applicable to transaction data; and
said POS terminal including (1) a device for reading or inputting data including both an ID of a customer and identity of products or services being purchased by said customer as part of a transaction and (2) a device for communicating information to said customer while said customer is conducting a transaction at said POS terminal.

2. The system of claim 1 wherein said threshold criteria depend upon transaction data for a plurality of transactions associated with the same customer ID.

3. The system of claim 1 wherein said threshold criteria depend upon movie showings data.

4. The system of claim 1 wherein said threshold criteria depend upon movie showings data including movie classification data defining classification or genre of movies.

5. The system of claim 1 wherein said threshold criteria depend upon movie showings data including movie ratings data defining ratings of movies.

6. The system of claim 1 wherein said threshold criteria depend upon movie showings data including movie ratings data defining ratings of movies.

7. The system of claim 1 wherein said threshold criteria depend upon movie transaction data defining customer's prior purchase of tickets for showings of movies.

8. The system of claim 1 wherein said threshold criteria depend upon movie transaction data defining classifications or ratings of movies for which a customer has previously purchased tickets for showings.

9. The system of claim 1 wherein said threshold criteria depend upon movie transaction data defining classifications or ratings of movies for which a customer has previously purchased tickets for showings and movie showings data including at least one of classifications and ratings of movies being shown or to be shown in the future in said at least one movie theater store.

10. The system of claim 1 wherein said terms for said consumer obtaining an incentive defined by said incentive offer include at least one purchase from said first POS computer system of at least one ticket for a showing of a movie, at least one food item, or at least one service item.

11. The system of claim 1 wherein said terms for said consumer obtaining an incentive defined by said incentive offer include at least one purchase from a second POS computer system other than said first POS computer system of at least of the following: a ticket for a showing of a movie at other than said at least one movie theater store, a food item, and a service item.

12. The system of claim 1 wherein said terms criteria determining terms for said consumer obtaining an incentive defined by said incentive offer comprise at least one of the following: a record in said database containing a customer ID used during a transaction, no record in said database containing said customer ID, currency volume of prior purchase stored in association with said customer ID, classification of movies tickets for showings of movies purchased in association with the same customer ID; number of tickets purchased for one showing of a movie purchased in association with said customer ID.

13. The system of claim 1 wherein said terms criteria determining terms for said consumer obtaining an incentive defined by said incentive offer comprise at least one of the following: existence of transactions associated with a customer ID transacted in other than said first POS system.

14. The system of claim 13 wherein said terms criteria comprise at least one of the following associated with a customer ID transacted in other than said first POS system: a record in said database containing a customer ID used during a transaction, no record in said database containing said customer ID, currency volume of prior purchase stored in association with said customer ID, classification of movies tickets for showings of movies purchased in association with the same customer ID; number of tickets purchased for one showing of a movie purchased in association with said customer ID.

15. The system of claim 1 wherein said threshold criteria depend upon movie showings data including difference in date of release of movies and current date.

16. The system of claim 1 wherein said threshold criteria depend upon time of day, day of week, or day of month.

17. The system of claim 1 wherein said other items comprise a food or beverage.

18. The system of claim 1 further comprising a central computer system and a network connecting said central computer system to said first POS computer system, wherein said stored movie showings data are stored in a database to which said central computer system has read and write access.

19. The system of claim 1 further comprising a central computer system and a network connecting said central computer system to said first POS computer system, wherein said stored incentive offer criteria are stored in a database to which said central computer system has read and write access.

20. The system of claim 1 wherein said device for reading or inputting data comprises at least one of a bar code reader and a key board.

21. The system of claim 1 wherein said device for communicating information to said customer comprises at least one of a visual display device and a printer.

22. The system of claim 1 wherein said threshold criteria depend upon transaction data for at least one previous transaction associated with the same customer ID as a customer ID associated with a current transaction.

23. A computer implemented method comprising:
storing movie showings data for at least one movie theater store defining movie showings in at least one theater in said at least one movie theater store storing transactions data defining transactions associated with said at least one movie theater store including at least one of purchase of tickets for showing of movies and purchase of other items sold by said movie theater store;
storing incentive offer criteria including at least one of (1) threshold criteria for determining whether an incentive offer should be communicated to a consumer and (2) terms criteria determining terms for said consumer obtaining an incentive defined by said incentive offer, wherein at least one of said threshold criteria and said terms criteria are applicable to transaction data; and
providing a first POS computer system, said first POS computer system comprising a central processing unit, memory, a database of information stored in said memory, and a POS terminal, said central processing unit having read write access to said database in said memory, said POS terminal designed to transmit transaction information and one or more customer IDs associated with a transaction to said central processing unit, and said POS terminal including (1) a device for reading or inputting data including both an ID of a customer and identity of products or services being purchased by said customer as part of a transaction and (2) a device for communicating information to said customer while said customer is conducting a transaction at said POS terminal.

24-43. (canceled)

44. A computer system comprising:
a first POS computer system, said first POS computer system comprising a first POS computer system central processing unit, a first POS computer system memory, first POS computer system database of information stored in said memory, and a first POS computer system POS terminal, said first POS computer system central processing unit having read write access to said first POS computer system database in said first POS computer system memory, said first POS computer system POS terminal designed to transmit transaction information and one or more customer IDs associated with a transaction to said first POS computer system central processing unit;
said first POS computer system database storing movie showings data for at least one movie theater store defining movie showings in at least one theater in said movie theater store and transactions data defining transactions associated with said at least one movie theater store including purchase of tickets for showing of movies and purchase of other items sold by said movie theater store;
a second POS computer system for a non-movie theater retail store, said second POS computer system comprising a second POS computer system central processing unit, a second POS computer system memory, a second POS computer system database of information stored in said memory, and a second POS computer system POS terminal, said second POS computer system central processing unit having read write access to said second POS computer system database in said second POS computer system memory, said second POS computer system POS terminal designed to transmit transaction information and one or more customer IDs associated with a transaction to said central processing unit;
said second POS computer system database storing transactions data for transactions including product purchase data for at least one product purchased in a non-movie theater retail store;
stored incentive offer criteria including at least one of (1) threshold criteria for determining whether an incentive offer should be communicated to a consumer and (2) terms criteria determining terms for said consumer obtaining an incentive defined by said incentive offer, wherein at least one of said threshold criteria and said terms criteria depend upon said transaction data; and
said second POS terminal including a device for reading or inputting data including both an ID of a customer and identity of products or services being purchased by said customer as part of a transaction and a device for communicating information to said customer while said customer is conducting a transaction at said second POS terminal.

45. The system of claim 44 further comprising code for linking transaction data for transactions transacted in the first POS computer system with transaction data for transactions transacted in the second POS computer system based at least in part upon geographic proximity of stores in which transactions occurred.

46. The system of claim 44 further comprising data stored linking a transaction data for transactions transacted through said first POS computer system associated with a first customer ID to transaction data for transaction transacted through said second POS computer system associated with a second customer ID.

47. The system of claim 44 further comprising code for determining whether stored incentive offer criteria are satisfied for a specified ID based upon data associated with transactions from both the first POS computer system and the second POS computer system.

48. The system of claim 44 further comprising code for communicating an incentive offer contingent upon purchasing in a non-movie theater store using said second POS computer system, and communicating said incentive offer to a customer having a customer ID when said customer ID or an ID associated with said customer ID is identified at said first POS computer system POS terminal in said movie theater store.

49. The system of claim 44 further comprising code for communicating an incentive offer contingent upon purchasing in said movie theater store using said first POS computer system, and communicating said incentive offer to a customer having a customer ID when said customer ID or an ID associated with said customer ID is identified at said second POS computer system POS terminal of said non-movie theater retail store.

50. The system of claim 49 wherein said non-movie theater retail store is one of a supermarket, a convenience store, and an gasoline or other motor vehicle fuel station.

51. The system of claim 44 further comprising a central computer system and a network connecting between said first POS computer system, said second POS computer system, and said central computer system.

52. The system of claim 51 wherein said central computer system has code for implementing real time processing.

53. The system of claim 51 wherein said central computer system contains a database storing transaction data in records each including fields for at least 7 of the following: consumer name 503, consumer address, consumer telephone number, consumer email address, ID, FSID, UPCs of items purchased, date of transaction, price of items purchased, credit card type 519, part or all of credit card number, credit card expiration date, fax number, first FSID, second FSID, first MID1, second MID2, and store ID.

54. The system of claim 51 wherein said central computer system contains a database storing location of stores in records each including fields for at least two of store ID, store location 605, store IP address, store URL, and store type.

55. The system of claim 44 wherein said first POS computer system contains a database storing movie releases data preferably including fields for at least 4 of the following: title 803, release date, schedule of viewing dates 807, first movie classification 809, second movie classification, movie rating 813, movie length 815, popularity index 817, movie theater store ID, store location, and store ID.

56. The system of claim 51 wherein said central computer system contains a database storing movie releases records including fields for storing at least 5 of the following: title, release date, schedule of viewing dates, first movie classification 909, second movie classification, movie rating 913, movie length, popularity index 917, movie theater store ID, store location, store ID, and movie theater system ID.

57. The system of claim 44 wherein said incentive offer criteria are stored in a central computer system.

58. A computer implemented method comprising:
providing a first POS computer system, said first POS computer system comprising a first POS computer system central processing unit, a first POS computer system memory, first POS computer system database of information stored in said memory, and a first POS computer system POS terminal, said first POS computer system central processing unit having read write access to said first POS computer system database in said first POS computer system memory, said first POS computer system POS terminal designed to transmit transaction information and one or more customer IDs associated with a transaction to said first POS computer system central processing unit;
storing in said first POS computer system database movie showings data for at least one movie theater store defining movie showings in at least one theater in said movie theater store and transactions data defining transactions associated with said at least one movie theater store including purchase of tickets for showing of movies and purchase of other items sold by said movie theater store;
providing a second POS computer system for a non-movie theater retail store, said second POS computer system comprising a second POS computer system central processing unit, a second POS computer system memory, a second POS computer system database of information stored in said memory, and a second POS computer system POS terminal, said second POS computer system central processing unit having read write access to said second POS computer system database in said second POS computer system memory, said second POS computer system POS terminal designed to transmit transaction information and one or more customer IDs associated with a transaction to said central processing unit;
storing in said second POS computer system database transactions data for transactions including product purchase data for at least one product purchased in a non-movie theater retail store;
storing incentive offer criteria including at least one of (1) threshold criteria for determining whether an incentive offer should be communicated to a consumer and (2) terms criteria determining terms for said consumer obtaining an incentive defined by said incentive offer, wherein at least one of said threshold criteria and said terms criteria depend upon said transaction data; and
reading or inputting data into said second POS terminal including both an ID of a customer and identity of products or services being purchased by said customer as part of a transaction and communicating information to said customer while said customer is conducting a transaction at said second POS terminal.

59-71. (canceled)
